(19) United States
(12) Patent Application Publication
(10) Pub. No.: US 2024/0396344 A1
(43) Pub. Date: Nov. 28, 2024

(54) METHOD AND APPARATUS FOR WIDE-RANGE ENERGY HARVESTING USING AUTO-CHANGE DUAL MODE MAXIMUM POWER POINT TRACKING

(71) Applicant: POSTECH Research and Business Development Foundation, Pohang-si (KR)

(72) Inventors: Jae Yoon SIM, Pohang-si (KR); Hee Sung ROH, Pohang-si (KR)

(73) Assignee: POSTECH Research and Business Development Foundation, Pohang-si (KR)

(21) Appl. No.: 18/493,683

(22) Filed: Oct. 24, 2023

(30) Foreign Application Priority Data
May 25, 2023 (KR) 10-2023-0067807

(51) Int. Cl. H02J 3/46; H02J 3/32; H02J 7/00; H02J 7/34; H02J 7/35; H02J 50/00

(52) U.S. Cl. CPC H02J 3/46; H02J 3/32; H02J 7/0047; H02J 7/00711; H02J 7/345; H02J 7/35; H02J 50/001; H02J 2300/26

(57) ABSTRACT

Disclosed is an energy harvesting method of an energy harvesting apparatus configured to convert input power coming from an energy source using a switching frequency, which is generated by monitoring an input voltage, and a first time and a second time, which are on-times of a first switch and a second switch, respectively, and generated based on the switching frequency, and deliver the converted input power to a battery.

### CROSS-REFERENCE TO RELATED APPLICATIONS

This application claims priority to Korean Patent Application No. 10-2023-0067807, filed on May 25, 2023, with the Korean Intellectual Property Office (KIPO), the entire contents of which are hereby incorporated by reference.

### BACKGROUND

### 1. Technical Field

The present disclosure relates to an energy harvester for an Internet of Things (IoT) device and the like, and relates to a wide-range energy harvesting method and apparatus using an auto-change dual mode maximum power point tracking algorithm based on an auto-adaptive low power circuit design with high conversion efficiency while being less sensitive to the type of an energy source and a change in external environment.

### 2. Related Art

Energy harvesters utilize energy generated in a surrounding environment, such as light energy or thermal energy, to supplement or replace the role of batteries used for Internet of Things (IoT) devices. The energy harvester is mainly used in IoT devices that are used in an environment in which a battery cannot be easily replaced or an environment that is constrained by the battery size.

When manufacturing the energy harvester, the absolute amount of energy harvested from an energy source is important, but the conversion efficiency of converting the energy into usable energy is also important, and thus, it is important to design the energy harvester to extract energy by tracking a maximum power point while reducing energy harvester's own power consumption and energy conversion losses.

That is, the energy harvester includes electrical circuits that consume power, and thus a low-power operation relative to the energy harvested is essential. Further, the energy harvester should have a wide input range since the range of power supplied by the energy source may vary widely depending on energy source types and environmental changes. In addition, a maximum power point tracking (MPPT) circuit is required to deliver the harvested energy to a battery with maximum efficiency.

In consideration of the above conditions, conventional techniques for designing energy harvesters can be largely divided into two types.

The first type is a fractional open-circuit voltage method. This method uses the fact that a maximum power point voltage VMPP is a constant multiple of an equivalent energy source open-circuit voltage. Since the maximum power point voltage VMPP is set to a predefined ratio, it is relatively very simple to implement as a circuit. An open-circuit voltage is converted by a constant multiple through a divider according to a ratio found through prior information and used as a target operating voltage.

The second type is a perturb-and-observe method. This method changes a target operating voltage in small increments, compares the target operating voltage with extracted power individually, and continues to change the target operating voltage until it reaches a voltage at which the extracted power is maximized. This method may determine an accurate maximum power point voltage by directly evaluating and comparing power coming from an energy source through an analog circuit and changing the target operating voltage in small increments to find out a voltage value at which the extracted power is maximized.

Meanwhile, in order to use the above-described fractional open-circuit voltage method, it is necessary to extract an accurate open-circuit voltage of an energy source. However, when sampling the open-circuit voltage, it is not possible to determine how long the open-circuit voltage to be sampled to reach the open-circuit voltage. In an environment in which energy is harvested well, the open-circuit voltage of the corresponding energy source is reached quickly, but in the opposite case, it takes a long time. Accordingly, it is difficult to predict a sampling time appropriate for the magnitude of energy harvested from the energy source, and the energy cannot be delivered to a battery while extracting the open-circuit voltage because a connection to a converter is disconnected, which reduces efficiency. In addition, in order to sample the open-circuit voltage and disconnect the connection to the converter, a switch circuit is required, but energy losses inevitably occur due to finite resistance components of the switch circuit.

In addition, when the above-described perturb-and-observe method is used, it is necessary to determine the magnitude of the energy harvested from the energy source. Both the currently set extraction voltage and current values should be sampled to directly evaluate the power coming from the energy source in the current state. In order to evaluate the harvested power through the sampled voltage and current values, the two values should be multiplied. In order to sample a voltage and a current, not only does a portion of the charges to be charged to the battery have to be used directly, but a complex analog circuit consuming a large amount of power is required for multiplication. Accordingly, even when the accurate maximum power point voltage is determined, the process of finding the accurate maximum power point voltage consumes a large amount of power and reduces conversion efficiency.

As described above, there is a need for an energy harvester having a new structure or operation method capable of solving the problems of the related art.

### SUMMARY

Exemplary embodiments of the present disclosure provide an energy conversion circuit designed to use harvested energy with high efficiency in wide-range input power environments while reducing its own power consumption relative to the energy harvested, by using a perturb-and-observe method, but implementing a maximum power point tracking (MPPT) circuit that indirectly detects the magnitude of the harvested energy and automatically selects between two modes, and an energy harvesting method and apparatus using the same.

Exemplary embodiments of the present disclosure also provide an auto-adaptive low-power circuit that converts energy harvested from an energy source into energy for driving Internet of thing (IoT) devices and has a high conversion efficiency despite the type of an energy source and a change in external environment, and an energy harvester based on the auto-adaptive low-power circuit.

Exemplary embodiments of the present disclosure also provide a wide-range energy harvesting method and apparatus using auto-change dual mode maximum power point tracking based on the above-described auto-adaptive low-power circuit.

According to a first exemplary embodiment of the present disclosure, an energy harvesting method of an energy harvesting apparatus configured to convert input power coming from an energy source using a switching frequency, which is generated by monitoring an input voltage, and a first time and a second time, which are on-times of a first switch and a second switch, respectively, and generated based on the switching frequency, and deliver the converted input power to a battery may comprise: counting a first number, which is the number of switching events for an on/off operation of the second switch during the first time, when the input power is less than a preset reference value; counting a second number of switching events of the second switch for each first time while changing a first input voltage from first input voltage-first time pairs pre-stored in relation to a preset fixed charge amount for the battery; and setting the first input voltage of the first time having the highest number of switching events among the second numbers obtained in the counting as a maximum power extraction voltage.

The first time may be proportional to a fractional value with the first input voltage as a denominator.

The reference value may be a power of several milliwatts (mW).

The energy harvesting method may further comprise setting an input voltage that causes the first time to be maximized as the maximum power extraction voltage, when the input power is greater than or equal to the reference value.

The energy harvesting method may further comprise: measuring a first current flowing to the battery through the second switch during the second time; measuring a second current flowing to the battery through the second switch during a third time obtained by changing the second time; and tracking the maximum power extraction voltage by comparing the first current and the second current.

According to a second exemplary embodiment of the present disclosure, an energy harvesting method of an energy harvesting apparatus configured to convert input power of an energy source using a switching frequency, which is generated by monitoring an input voltage, and a first time and a second time, which are on-times of a first switch and a second switch, respectively, and generated based on the switching frequency, and store the converted input power in a battery may comprise: maximizing a system frequency of the energy harvesting apparatus when the input power is greater than or equal to a preset reference value; adjusting the first time that determines an amount of charge delivered to the battery; measuring a current flowing to the battery through the second switch according to the adjustment of the first time; and tracking a maximum power point on the basis of a comparison result of the currents flowing to the battery.

The energy harvesting method may further comprise shortening a period of the system frequency to increase a system clock per unit time, when the input power is greater than or equal to the reference value.

The measuring of the current may include measuring a first current flowing to the battery at the first time using a current mirror, and measuring a second current flowing to the battery at another first time obtained by changing the first time using the current mirror, and the tracking of the maximum power point may include comparing a first capacitor voltage and a second capacitor voltage, which are charged to a first capacitor and a second capacitor connected to the current mirror, respectively.

The energy harvesting method may further comprise changing an operation mode when the input power is less than the reference value.

The energy harvesting method may further comprise: counting, in the changed operation mode, a second number of switching events of the second switch while changing a first input voltage from first input voltage-first time pairs pre-stored in relation to a preset fixed charge amount for the battery; and setting, in the changed operation mode, the first input voltage at the first time having the highest number of switching events among the second numbers, which are obtained in the counting of the second number, as a maximum power extraction voltage.

According to a third exemplary embodiment of the present disclosure, an energy harvesting apparatus configured to convert input power coming from an energy source and deliver the converted input power to a battery may comprise: a first switch connected between a point between an input terminal and an output terminal, and the ground; a second switch serially connected to the point between the input terminal and the output terminal, and disposed adjacent to the output terminal; a switch pulse generator configured to generate a system frequency and a trigger signal by monitoring an input voltage, generate a switching frequency on the basis of the system frequency, generate a first time and a second time, which are on-times of the first switch and the second switch, respectively, on the basis of the switching frequency, and generate a first control signal for the first switch and a second control signal for the second switch on the basis of the first time and the second time; and a maximum power point tracking (MPPT) part configured to generate a mode selection signal for selecting an operation mode on the basis of the trigger signal, and generate a digital code using one of a first MPPT engine and a second MPPT engine activated according to the mode selection signal, wherein the switch pulse generator operates in a first operation mode when the input voltage is less than a preset reference value, and shortens a period of the system frequency and operates in a second operation mode when the input voltage is greater than or equal to the reference value.

The switch pulse generator may include: a voltage divider configured to generate a reference voltage obtained by dividing a battery voltage on the basis of a first digital signal generated by the first MPPT engine; and a comparator configured to compare the input voltage with the reference voltage corresponding to the reference value, and generate a comparator output for indicating an active or enabled state when the input voltage is greater than or equal to the reference voltage.

The switch pulse generator may further include: a digitally controlled oscillator configured to generate the system frequency according to the comparator output and output a flag which is the trigger signal at a maximum system frequency; an OR gate having the comparator output and a second digital signal generated in the second MPPT engine as two inputs; and an AND gate having an output of the OR gate and the system frequency as two inputs.

The energy harvesting apparatus may further comprise: a pulse-width modulation (PWM) part having the switching frequency, which is an output of the AND gate, the first digital signal, and the second digital signal as three inputs and configured to output the first time; a zero current detection (ZCD) part having the first time transmitted from the PWM part, the battery voltage, and an internal input voltage applied to a first terminal of the second switch at a source side as three inputs, and configured to output the second time; and a switch driver having the first time, the second time, and the battery voltage as three inputs and configured to output the first control signal and the second control signal.

When the comparator output is greater than or equal to the reference value, the digitally controlled oscillator may maximize the system frequency of the energy harvesting apparatus, and the PWM part may change the first time that determines an amount of charge delivered to the battery.

When the comparator output is greater than or equal to the reference value, the digitally controlled oscillator may increase the system frequency by two times, and when the comparator output is changed below the reference value, the digitally controlled oscillator may return the system frequency or reduce the system frequency by ½.

The energy harvesting apparatus may further comprise: a measurement part configured to measure a current flowing to the battery through the second switch during each changed first time; a comparison part configured to compare the currents flowing to the battery, which are measured according to the changing of the first time; and a tracking part configured to track a maximum power point on the basis of a comparison result of the comparison part.

The comparison part may include a current mirror, and a first capacitor and a second capacitor connected in parallel to an output terminal of the current mirror at one side, wherein each of the first capacitor and the second capacitor copies and stores the currents flowing to the battery for different first times.

The energy harvesting apparatus may further comprise: a storage part configured to store first input voltage-first time pairs, which correspond to a fixed amount of charge, preset for the battery; a first counter configured to count a first number, which is the number of switching events for an on/off operation of the second switch during a preset time, when the comparator output is less than the reference value; a second counter configured to count a second number of switching events of the second switch for each first time corresponding to a first input voltage extracted from the storage part while changing the first input voltage, when the comparator output is less than the reference value; and a tracking part configured to set a first input voltage at the first time having the highest number of switching events among the second numbers obtained by the second counter as a maximum power extraction voltage.

A reference value of an input current according to the reference voltage may be a power of several milliwatts (mW).

In some exemplary embodiments, an energy harvesting apparatus includes a processor and a memory for storing a program command executed by the processor. Here, when the processor is executed by the program command, the processor is configured to perform operations of determining whether an input power is greater than or equal to a preset reference value and counting a first number, which is the number of switching events for an on/off operation of the second switch during the first time, when the input power is less than the reference value, counting a second number of switching events of the second switch for each first time while changing a first input voltage from first input voltage-first time pairs pre-stored in relation to a preset fixed charge amount for the battery, and setting the first input voltage of the first time having the highest number of switching events among the second numbers obtained in the counting as a maximum power extraction voltage.

In some exemplary embodiments, an energy harvesting apparatus includes a processor and a memory for storing a program command executed by the processor. Here, when the processor is executed by the program command, the processor may be configured to perform operations of determining whether an input power is greater than or equal to a preset reference value and maximizing a system frequency of the energy harvesting apparatus when the input power is greater than or equal to the reference value, adjusting the first time that determines an amount of charge delivered to the battery, measuring a current flowing to the battery through the second switch according to the adjustment of the first time, and tracking a maximum power point on the basis of a comparison result of the currents flowing to the battery.

According to the present disclosure, it is possible to provide an energy harvesting method and apparatus that can replace current monitoring by fixing charges delivered to a battery during a single operation of an energy harvester and counting the charges for a predetermined period of time in consideration of conduction loss.

In addition, according to the present disclosure, it is possible to provide an adaptive low-power circuit that can detect the magnitude of harvested energy and automatically track a maximum power point in consideration of energy conversion loss.

In addition, according to the present disclosure, it is possible to provide an energy harvesting circuit using an automatically changeable dual mode maximum power point tracking algorithm. By using the energy harvesting circuit, energy harvesting efficiency can be greatly improved by applying new rules in a power conversion process instead of using a conventional analog circuit that consumes a large amount of power.

In addition, according to the present disclosure, a limited low-capacity rechargeable battery can be effectively charged by using the above-described energy harvesting circuit. That is, when an Internet of Things (IoT) device is equipped with a battery to drive the IoT device, power can be supplied to a battery with excellent conversion efficiency with respect to input power without being sensitive to the type of an energy source and a change in external environment.

### BRIEF DESCRIPTION OF DRAWINGS

FIG. 1 is a block diagram of a wide-range energy harvesting apparatus (hereinafter simply referred to as an “energy harvester”) using automatically changeable dual mode maximum power point tracking according to one exemplary embodiment of the present disclosure.

FIGS. 2 and 3 are graphs for describing the operation principle of the energy harvester of FIG. 1.

FIG. 4 is an exemplary diagram for describing a PWM circuit that may be employed in the energy harvester of FIG. 1 and an operation principle thereof.

FIG. 5 is an exemplary diagram for describing a ZCD circuit that may be employed in the energy harvester of FIG. 1 and an operation principle thereof.

FIG. 6 is a partial circuit diagram for describing a dual mode maximum power point tracking principle of the energy harvester of FIG. 1.

FIG. 7 is a graph for describing an energy harvesting principle according to the operation of the energy harvester of FIG. 6.

FIGS. 8 and 9 are diagrams for describing a relationship between an internal power loss ratio and a dual-mode operation of the energy harvester of FIG. 6.

FIG. 10 is a graph for describing conditions for fixing the amount of charge in the FCS mode of the energy harvester of FIG. 1.

FIG. 11 is a graph for describing the relationship between input voltage-first time pairs obtained in the FCS mode of FIG. 10.

FIG. 12 is a flowchart of an operation process of the FCS mode that may be employed in the energy harvester of FIG. 1.

FIG. 13 is a graph for describing a transient response showing an FCS-MPPT operation in an environment in which an open-circuit voltage Voc is changed in the energy harvester of FIG. 1.

FIG. 14 is a graph for describing FFS-MPPT that may be employed in the energy harvester of FIG. 1.

FIG. 15 is an exemplary diagram of a control circuit configured to compare harvested charges in the FFS mode that may be employed in the energy harvester of FIG. 1.

FIG. 16 is a flowchart illustrating an operation process of the FFS mode of FIG. 14.

FIG. 17 is a die photograph of a structure that may be employed in the energy harvester of FIG. 1.

FIG. 18 is a graph for describing a transient response showing a ZCD in the energy harvester of FIG. 1.

FIG. 19 is a graph for describing a transient response showing a mode change from the FCS mode to the FFS mode in the energy harvester of FIG. 1.

FIG. 20 is a graph for describing a transient response showing a steady state of the FFS-MPPT in the energy harvester of FIG. 1.

FIG. 21 is a graph showing conversion efficiency of the energy harvester of FIG. 1 measured for various input powers under various open-circuit voltage conditions at a constant battery voltage.

FIG. 22 is a graph showing a result of verifying the energy harvester of FIG. 1 with a commercial solar cell exposed to various light intensities.

FIG. 23 is a schematic block diagram of an energy harvesting apparatus according to another exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

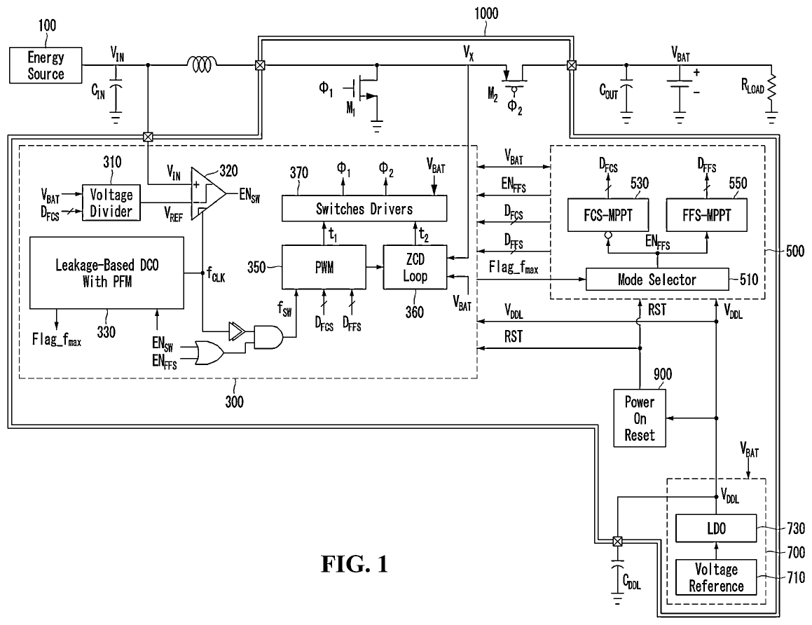

FIG. 1 is a block diagram of a wide-range energy harvesting apparatus (hereinafter simply referred to as an “energy harvester”) using automatically changeable dual mode maximum power point tracking according to one exemplary embodiment of the present disclosure.

Referring to FIG. 1, an energy harvester 1000 may be provided in the form of an integrated circuit (IC) having input terminals and output terminals. The energy harvester 1000 may be connected to an energy source 100 via an input capacitor C_{IN} and/or an inductor that are connected to the input terminals. The energy source 100 may include light energy, thermal energy, and the like generated in the environment surrounding the energy harvester 1000. In addition, the energy harvester 1000 may be connected to a battery and/or a load R_{LOAD} via an output capacitor C_{OUT} connected in parallel to the output terminal.

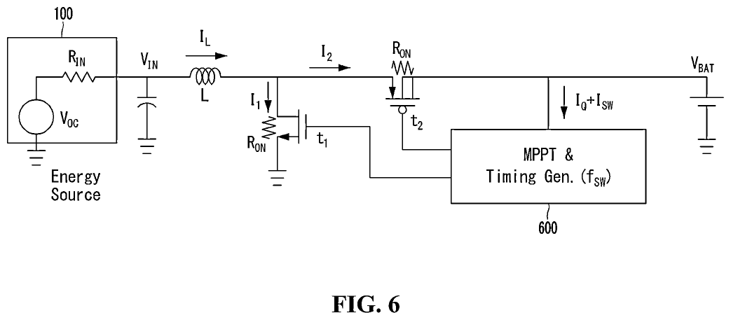

The energy harvester 1000 may be fabricated using an 180 nm complementary metal-oxide-semiconductor (CMOS) on an area of 1.42 mm² (see FIG. 17). In the energy harvester 1000, the capacitance of each of the input capacitor C_{IN}, the output capacitor C_{OUT}, and a ground capacitor C_{DDL} may all be 20 μF, the inductance of an inductor L (see FIG. 6) connected to an input side of the energy harvester 1000 may be 82 μH, and a battery voltage V_{BAT} connected to an output side of the energy harvester 1000 may be set to 3.3 V. In a simulation process, the energy source 100 of the energy harvester 1000 may be modeled with a voltage source Voc with a variable output resistor.

The above-described energy harvester 1000 may be mounted on Internet of Things (IoT) devices used in environments in which a battery is not easily replaceable or a battery size is constrained.

Further, the energy harvester 1000 may include a first switch M₁ connected in parallel between the input terminal and the output terminal and a second switch M₂ connected in series. A gate voltage of each of the first switch M₁ and the second switch M₂ may be set to be driven directly by the battery voltage V_{BAT} to reduce a resistance component R_{ON} of the switch.

The first switch M₁ may have an n-type semiconductor switch structure having a first terminal, a second terminal, and a control terminal, and the second switch M₂ may have a p-type semiconductor switch structure having a first terminal, a second terminal, and a control terminal. The control terminal of each of the switches M₁ and M₂ may be referred to as a gate.

In addition, the energy harvester 1000 may include a switch pulse generator (SPG) 300 for monitoring an input voltage V_{IN} or input power P_{IN} and controlling operations of the first switch M₁ and the second switch M₂ of the energy harvester 1000. The SPG 300 may include a voltage divider 310, a comparator 320, a digitally controlled oscillator (DCO) 330, a buffer, an OR gate, an AND gate, a pulse-width modulation (PWM) part 350, a zero current detection (ZCD) part 360, and a switch driver 370.

The voltage divider 310 may receive the battery voltage V_{BAT} and a first digital code D_{FCS} as inputs, and output a reference voltage V_{REF}, which is a preset level obtained by dividing the battery voltage V_{BAT} according to the first digital code D_{FCS}. The voltage divider 310 may be implemented as metal oxide semiconductor (MOS) transistors in a series-connected diode configuration.

The comparator 320 may compare the input voltage V_{IN} with the reference voltage V_{REF} and generate a comparator output EN_{SW}. The comparator 320 may be referred to as an input voltage monitoring comparator.

The DCO 330 may receive the comparator output EN_{SW} as an input and output a predetermined clock f_{CLK} (hereinafter, referred to as a “first clock”). The first clock may be referred to as a first frequency or system frequency. The first clock f_{CLK} may be transmitted to a third input of the comparator 320 to specify an operation cycle and/or a response time of the comparator 320. In addition, the DCO 330 may output a flag Flag_fₘₐₓ at a maximum frequency, at which the frequency of the first clock is maximized. The DCO 330 may include a leakage-based DCO and may have a pulse-frequency modulation (PFM) function.

The AND gate may operate to output another predetermined clock f_{SW} (hereinafter, referred to as a “second clock”), which is a clock based on the first clock f_{CLK}, or not to output the second clock f_{SW}, according to an output value of the OR gate. The second clock may be referred to as a second frequency or switching frequency. The buffer may be disposed at an input terminal of the AND gate, to which the first clock f_{CLK} is input. Here, the OR gate may receive the comparator output EN_{SW} and a mode selection signal EN_{FFS} as two inputs, and may output “1” or an enable signal when one or more of the two inputs is “1” or in an enable state.

The PWM part 350 may receive the second frequency f_{SW}, the first digital code D_{FCS}, and a second digital code D_{FFS} as inputs, and output a first time t₁.

The ZCD part 360 may receive the first time t₁, the battery voltage V_{BAT}, and an internal input voltage Vx as inputs, and output a second time t₂. The internal input voltage Vx may be a voltage commonly applied to a first terminal of the first switch M₁ and a first terminal of the second switch M₂. The ZCD part 360 may include a zero current detection (ZCD) loop.

The switch driver 370 may receive the battery voltage V_{BAT}, the first time t₁, and the second time t₂ as inputs, and may output a first control signal Φ₁ applied to the gate of the first switch M₁ and a second control signal Φ₂ applied to the gate of the second switch M₂.

In addition, the energy harvester 1000 may include a maximum power point tracking (MPPT) part 500, which is triggered by the flag generated by the SPG 300 at the maximum operating frequency and generates the digital code D_{FCS} or D_{FFS} of the MPPT mode that is selected from among two MPPT modes according to a predetermined criterion for the flag. The MPPT part 500 may include a mode selector 510, a fixed charge search (FCS)-MPPT part 530, and a fixed frequency search (FFS)-MPPT part 550, and may be referred to as an MPPT engine.

The mode selector 510 receives the signal of the flag Flag_fₘₐₓ from the DCO 330 and outputs the mode selection signal EN_{FFS}.

The FCS-MPPT part 530 may include an FCS circuit that operates at the input power P_{IN} of a relatively low power of less than 1 mW. The FFS-MPPT part 550 may include an FFS circuit that operates at the input power P_{IN} of a relatively high power of 1 mW or more at which the FCS-MPPT part 530 may not operate.

An input terminal of the FCS-MPPT part 530 may be configured to receive an inverted value or level of the mode selection signal EN_{FFS}, and an input terminal of the FFS-MPPT part 550 may be configured to directly receive a value or level of the mode selection signal EN_{FFS}.

In the MPPT part 500, each of the mode selection signal EN_{FFS} generated in the mode selector 510, the first digital code D_{FCS} generated in the FCS-MPPT part 530, and the second digital code D_{FFS} generated in the FFS-MPPT part 550 may be transmitted to the SPG 300.

In addition, the energy harvester 1000 may include a regulator 700 configured to supply power to the SPG 300 and the MPPT part 500. The regulator 700 may include a low drop-output (LDO) 730, which is a linear regulator that operates even at a low input/output potential difference, and a voltage regulator 710 configured to output a reference voltage to the LDO 730.

The regulator 700 may be formed as at least one integrated circuit (IC). The voltage regulator 710 may include a programmable voltage regulator. In addition, the LDO 730 may be used to supply a predetermined level of a power supply voltage V_{DDL}, such as 1.8 V, to the internal circuits. This internal LDO 730 may be driven by a low-power bandgap reference circuit.

In addition, the energy harvester 1000 may further include a power-on reset (POR) part 900 for power-on reset. Wirings may be connected between the POR part 900 and the SPG 300 and between the POR part 900 and the MPPT part 500 to transmit a reset signal RST of the POR part 900.

In the above-described energy harvester 1000, the battery voltage V_{BAT} may be applied to each of the voltage divider 310 and the ZCO part 360 of the SPG 300, the MPPT part 500, and the regulator 700 via the output terminal of the energy harvester 1000. In addition, the power supply voltage V_{DDL} of the regulator 700 may be supplied to each of the SPG 300, the MPPT part 500, and the regulator 700.

An operation principle of the above-described energy harvester 1000 will be described as follows.

The first switch M₁ and the second switch M₂ may be operated according to the second frequency f_{SW}, which is a switching frequency generated by the SPG 300, and the first time t₁ and the second time t₂, which are on times of the switches M₁ and M₂, respectively.

To this end, monitoring of the input power P_{IN} or input voltage V_{IN} may be performed in synchronization with the first clock f_{CLK} generated by the DCO 330. Specifically, the input voltage V_{IN} applied to the energy harvester 1000 from the energy source 100 via the input capacitor C_{IN} may be compared with the reference voltage V_{REF} by the comparator 320. That is, when the input voltage V_{IN} reaches the value of the reference voltage V_{REF} determined by the voltage divider 310, the value of the output EN_{SW} of the comparator 320 may be “1.” Here, the reference voltage V_{REF} output from the voltage divider 310 may have a variable value updated according to the battery voltage V_{BAT} and the first digital code D_{FCS} that is an output of the FCS-MPPT part 530.

When the value of the comparator output EN_{SW} is “1,” the DCO 330 receiving the comparator output EN_{SW} may monitor the input voltage V_{IN} by setting a period of the first clock f_{CLK} to a preset operating period, and preferably, may monitor the input voltage V_{IN} at high speed by halving the period. When the value of the comparator output EN_{SW} is not “1” or is “0,” the DCO 330 may double the period of the first clock f_{CLK}, and observe the input voltage at a reduced speed or default setting. With this configuration, when the input power P_{IN} coming from the energy harvester 1000 is strong or large, the value of the comparator output EN_{SW} will frequently be “1,” and thus the period of the first clock f_{CLK} is shortened. In addition, in the opposite case, when the input power P_{IN} is not strong or not large, the value of the comparator output EN_{SW} will infrequently be “1” or will mostly be “0,” and thus the period of the first clock f_{CLK} become longer. Accordingly, the operation frequency is automatically set to match the value of the input voltage V_{IN}, making the operation of the energy harvester 1000 efficient and reducing unnecessary power consumption.

Meanwhile, when the input power P_{IN} is increased to 1 mW or more in the SPG 300, the maximum frequency that can be generated by the DCO 330 is reached, and a trigger called flag Flag_fₘₐₓ is generated at the maximum frequency. When the trigger occurs, the operation mode of the energy harvester 1000 may be automatically changed from an FCS-MPPT mode to an FFS-MPPT mode, and when the trigger disappears, the operation mode of the energy harvester 1000 may be returned to the FCS-MPPT mode again. Accordingly, the energy harvester 1000 may operate with an MPPT algorithm optimized for the input power P_{IN}, thereby highly efficiently converting the power coming from the energy source 100 through active and efficient MPPT and charging the battery.

According to the configuration of the energy harvester 1000 of the present exemplary embodiment as described above, energy can be converted with high efficiency in a range of 12 nW<P_{IN}<180 mW, which is a relatively wide input power range. In particular, a conversion efficiency of 30% or more can be obtained through FFS-MPPT in a relatively low input power range of less than 1 mW, and excellent conversion efficiency can be obtained through FFS-MPPT in a relatively high input power range of 1 mW or more. In particular, in the input power as low as 180 mW, a very excellent conversion efficiency of 80% or more can be obtained. In addition, the maximum power point can be tracked by changing the frequency quickly even when the magnitude of the input power is frequently changed due to environmental changes.

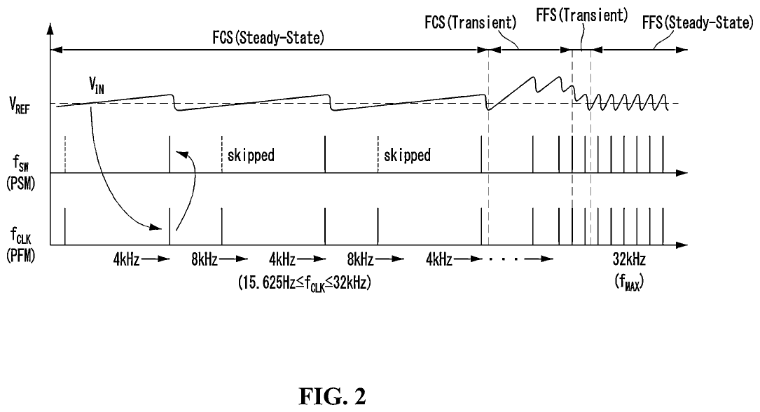

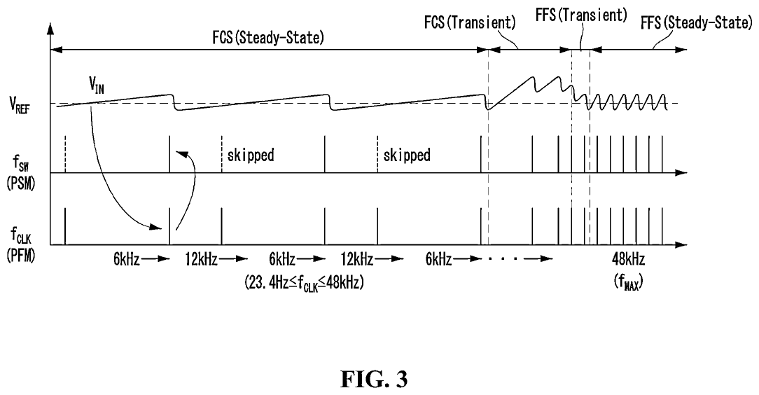

FIGS. 2 and 3 are graphs for describing the operation principle of the energy harvester of FIG. 1.

Referring to FIGS. 2 and 3, when the input voltage V_{IN} becomes greater than the reference voltage V_{REF} while being monitored by the comparator in an FCS mode, which is a steady-state operation mode of the energy harvester, the period of the first clock f_{CLK} of the DCO is shortened by ½ to bring the input voltage V_{IN} below the reference voltage V_{REF}, and the number of monitoring cycles is then reduced while skipping the second clock f_{SW} and monitoring at a relatively high speed, thereby reducing the power consumption of the energy harvester.

In addition, when the operation frequency of the DCO approaches the maximum frequency fₘₐₓ, the steady state FCS mode may be switched to a transient FCS mode, or may be switched to a transient FFS mode through the transient FCS mode, and when the frequency of the DCO reaches the maximum frequency fₘₐₓ and a flag is output, and the mode selector is triggered by the flag, the operation mode of the energy harvester may switch from the steady-state FCS mode to an FFS mode.

As illustrated in FIG. 2, the maximum frequency fₘₐₓ may be 32 kHz when the frequency of the first clock f_{CLK} of the DCO is in the range of 15.625 Hz or more to 32 kHz or less. In addition, as illustrated in FIG. 3, the maximum frequency fₘₐₓ may be 48 kHz when the frequency of the first clock f_{CLK} of the DCO is in the range of 23.4 Hz or more to 38 kHz or less. The maximum frequency fₘₐₓ may be referred to as a maximum clock frequency.

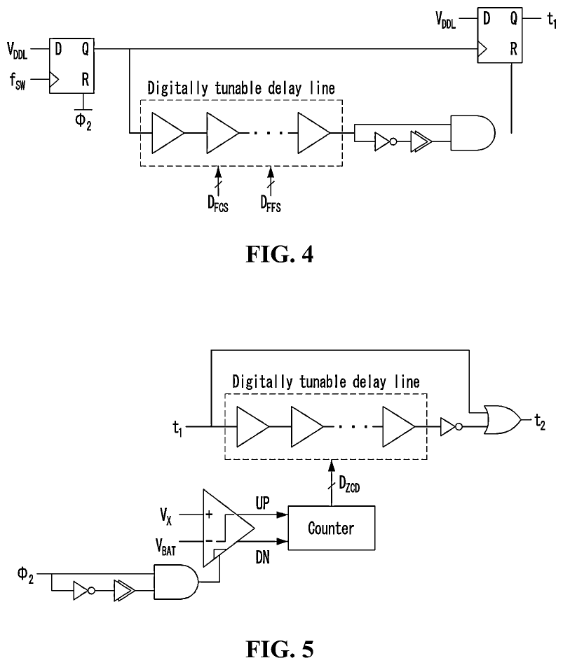

FIG. 4 is an exemplary diagram for describing a PWM circuit that may be employed in the energy harvester of FIG. 1 and an operation principle thereof. In addition, FIG. 5 is an exemplary diagram for describing a ZCD circuit that may be employed in the energy harvester of FIG. 1 and an operation principle thereof.

In the present exemplary embodiment, the energy harvester may include a PWM circuit in the PWM part, and may include a ZCD circuit in the ZCD part.

Referring to FIG. 4, the PWM part may control the first time t₁ through PWM by using the digital codes D_{FCS} and D_{FFS} generated in the MPPT part. To this end, the PWM circuit may include a first flip-flop, a delay line, and a second flip-flop. The first flip-flop and the second flip-flop may each be an edge trigger D flip-flop, and the delay line may be a digitally tunable delay line (DTDL) (hereinafter referred to a “first DTDL”). The first digital code D_{FCS} and the second digital code D_{FFS} may be transmitted to the first DTDL.

The first flip-flop may generate a first output waveform Q triggered at a clock of the second frequency f_{SW}, e.g., at a rising edge of the clock, and the second flip-flop may output a second output waveform triggered at a clock of the first output waveform Q. The second output waveform may include the first time t₁. The power supply voltage V_{DDL} may be applied to each of the first flip-flop and the second flip-flop, and the first flip-flop may be set to be reset by the second control signal Φ₂.

In FIG. 4, the first time t₁ may be controlled by PWM modulation of the PWM circuit using the digital codes generated by the MPPT part. At this time, the second frequency f_{SW} may be determined through PFM and pulse skip modulation (PSM) driven by the leakage-based DCO and the input voltage monitoring comparator.

That is, in relation to the second frequency f_{SW}, the input voltage V_{IN} in the form of a time-varying variable is compared with the reference voltage V_{REF} provided by the voltage divider. At this time, the reference voltage V_{REF} is a variable updated by the FCS-MPPT part, and eventually settles to a maximum power point voltage VMPP in a steady state. The first clock f_{CLK}, which is a system clock, may be provided by the leakage-based DCO. The first clock f_{CLK} repeatedly doubled or halved in frequency according to the comparator output EN_{SW} of a PFM engine mounted in the DCO, and may be adaptively changed within a preset frequency range, for example, from 23.4 Hz to 48 kHz. Only when the input voltage V_{IN} exceeds the reference voltage V_{REF} under a condition in which the comparator output EN_{SW} is “1” or in an enable state, the first clock f_{CLK} may be switched into the second clock f_{SW}. which may be transmitted to the PWM part. In a condition in which the comparator output EN_{SW} is not “1” or not in the enable state, switching of the first clock f_{CLK} may be skipped or the input of the second clock f_{SW} to the PWM part may be omitted.

In addition, as shown in FIG. 5, an optimal second time t₂ for the first time t₁ provided through the PWM circuit may be automatically generated through the ZCD part so that a reverse current does not flow in the battery voltage V_{BAT}. This second time t₂ may be generated by a digital control servo loop (DCSL) for the ZCD part.

The DCSL may include a ZCD comparator configured to compare the internal input voltage Vx with the battery voltage V_{BAT}, a counter configured to count up (UP) and down (DN) outputs of the ZCD comparator, and a digitally tunable delay line (hereinafter referred to a “second DTDL”) controlled by a ZCD digital code D_{ZCD} generated by the counter. A logic gate for transmitting an output clock to a control terminal of the ZCD comparator according to the second control signal Φ₂ generated by the switch driver may be provided.

In addition, the DCSL may include an OR gate having a first input waveform, which corresponds to the first time t₁, and a second input waveform, which is obtained by outputting the first input waveform through the second DTDL and a NOT gate, as two inputs, and with this configuration, the DCSL may generate an output waveform corresponding to the second time t₂.

Next, with the circuit design background of the energy harvester described above, a design principle of an auto-change dual mode maximum power point tracking circuit that considers loss factors for each input power range will be described.

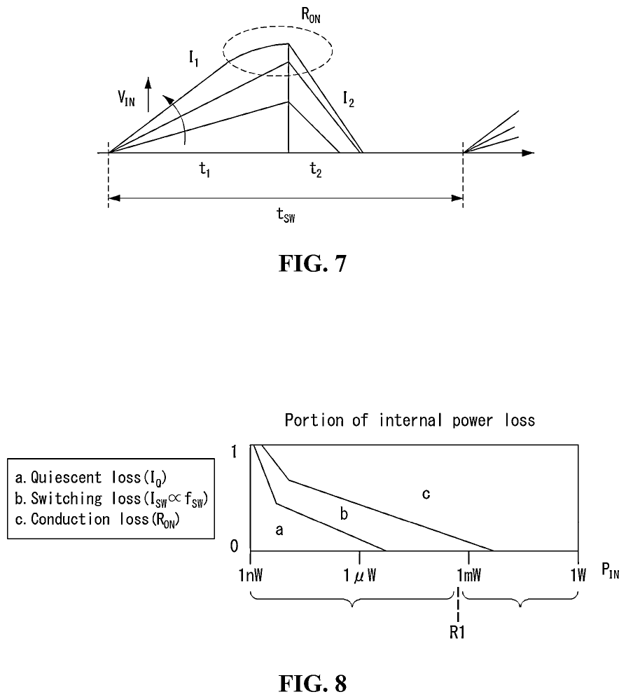

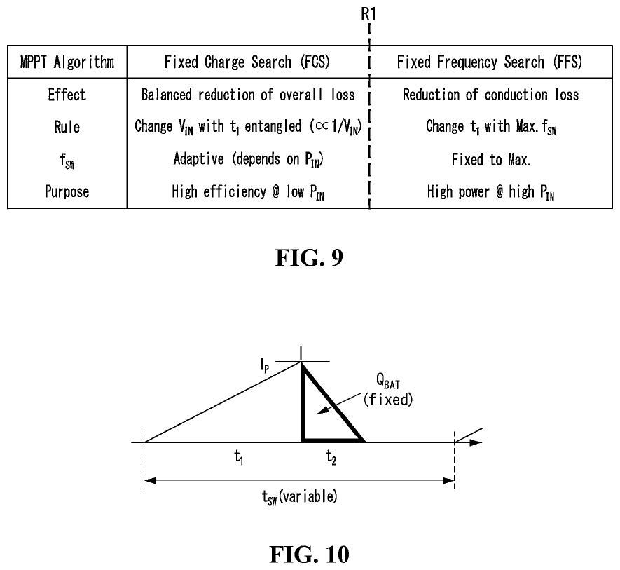

FIG. 6 is a partial circuit diagram for describing a dual mode maximum power point tracking principle of the energy harvester of FIG. 1. FIG. 7 is a graph for describing an energy harvesting principle according to the operation of the energy harvester of FIG. 6. FIGS. 8 and 9 are diagrams for describing a relationship between an internal power loss ratio and a dual-mode operation of the energy harvester of FIG. 6.

Referring to FIGS. 6 to 8, when energy harvested from the energy source 100 is delivered to the battery according to switching operations of the switches during the first time t₁ and the second time t₂, an internal power loss occurs due to three factors including a quiescent loss a, a switching loss b, and a conduction loss c. In FIG. 7, an MPPT & Timing Generator 600 configured to control an on-time of each of the switches during the first time t₁ and the second time t₂ may have a structure including the switch pulse generator and the MPPT part of FIG. 1.

The conduction loss is a loss caused by a resistance component R_{ON} of a semiconductor switch, such as a metal oxide semiconductor field effect transistor (MOSFET) switch. The switching loss is a loss that occurs when the MOSFET switch is turned on and off. In addition, the quiescent loss is a loss due to a current consumed by the MPPT circuit itself when the switches of the energy harvester are not operated.

Due to the above-described reasons, when a maximum power point tracking analog circuit consuming a large amount of power is used, energy conversion efficiency is greatly lowered at the input power P_{IN} of 1 μW or less, in which the quiescent loss is highly affected.

In view of these problems, as shown in FIGS. 8 and 9, the energy harvester according to the present exemplary embodiment operates with a new MPPT algorithm called a fixed charge search (FCS)-MPPT at the input power less than a reference R1 of 1 mW, which ensures a high energy conversion efficiency even at the input power P_{IN} of 1 uW or less. In such an energy harvester, the maximum power point tracking analog circuit is removed.

In addition, the energy harvester is configured to automatically switch to another MPPT algorithm called a fixed frequency search (FFS)-MPPT, which minimizes the conduction loss, when the input power P_{IN} of 1 mW or more is detected, so that the energy is accumulate with high efficiency. The FFS-MPPT is optimized for receiving high input power.

As described above, the energy harvester of the present exemplary embodiment can maximize energy conversion efficiency by using the MTTP algorithm that can operate by adaptively switching between the FCS mode and the FFS mode in real time according to the preset reference R1. The reference R1 may be referred to as a reference input voltage or a reference input power.

An effect, a rule, the switching frequency (f_{SW}), and a purpose of the FCS mode and the FFS mode of the MTTP algorithm may be summarized as shown in FIG. 9.

That is, the FCS mode can have an effect of balanced reduction of overall loss, a rule of changing the input voltage V_{IN} at the first time t₁ when the input voltage is entangled to a relatively small voltage, such as 1/input voltage level (∝1/V_{IN}), the adaptive switching frequency that depends on the input power P_{IN}, and a purpose of achieving high efficiency at the relatively low input power P_{IN}.

In addition, the FFS mode may have an effect of reduction of conduction loss, a rule of changing the first time t₁ to have the maximum switching frequency f_{SW}, the switching frequency f_{SW} fixed to a maximum value, and a purpose of achieving high power at the relatively high input power P_{IN}.

As described above, the energy harvester may operate by automatically switching between modes at any time with the optimized MPPT algorithm that detects input power and selects the mode based on the range of input power among two MPPT modes that take losses into account.

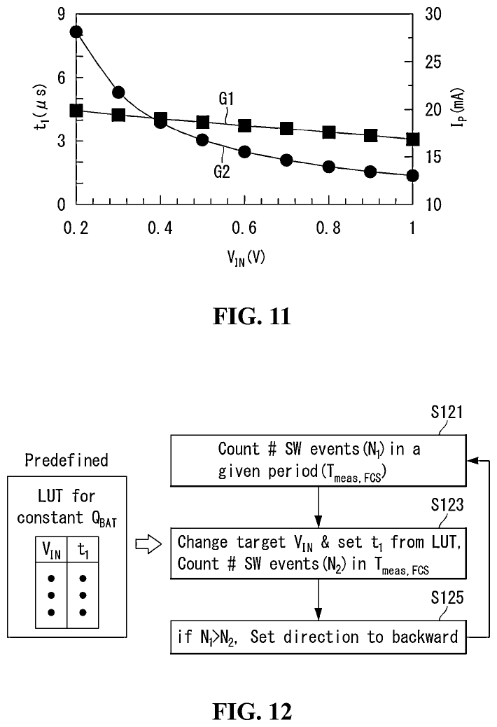

FIG. 10 is a graph for describing conditions for fixing the amount of charge in the FCS mode of the energy harvester of FIG. 1. FIG. 11 is a graph for describing the relationship between input voltage-first time pairs obtained in the FCS mode of FIG. 10. In addition, FIG. 12 is a flowchart of an operation process of the FCS mode that may be employed in the energy harvester of FIG. 1.

In the energy harvester of the present exemplary embodiment, an FCS-MPPT circuit operating at the low input power P_{IN} of 1 mW or less is used to design an MPPT circuit that tracks a maximum power point without using an analog circuit that consumes a large amount of power in maximum power point tracking. The FCS-MPPT circuit may be provided in the FCS-MPPT part 530 (see FIG. 1), and may be referred to as an FCS-MPPT engine, a first MPPT circuit, or a first MPPT engine.

Referring to FIG. 10, when a maximum current generated in a single operation of the energy harvester, i.e., generated in a switching time t_{SW} including the first time t₁ and the second time t₂, which are on-times of the switches (see M₁ and M₂ of FIG. 1, and FIG. 6) having a variable switching time t_{SW}, is referred to as I_{P}, when the conduction loss is small enough to be negligible compared to the harvested power, the amount of charge delivered to the battery in the single operation of the energy harvester may be calculated as a predetermined or fixed value as shown in FIG. 10 by a bold triangle-shaped region. Here, when the conduction loss is expressed as I_{P}²R_{ON}, and the harvested power is expressed as I_{P}V_{IN}, the relationship thereof may be expressed by Equation 1 below,

$${I}_{P}^{2} {R}_{O N} << {I}_{P} {V}_{IN} \qquad [ Equation 1 ]$$

When an inductance of the inductor L (see FIG. 6) connected to the energy harvester is fixed, a value of the maximum current I_{P} described above may be determined from the input voltage V_{IN} and the first time t₁. The maximum current I_{P} may be expressed by Equation 2 below,

$${I}_{P} = \frac{{V}_{IN} {t}_{1}}{L} \qquad [ Equation 2 ]$$

In addition, the amount of charge delivered to the battery, that is, a charge amount Q_{BAT} (hereinafter, simply referred to as “charge Q_{BAT}”) accumulated in the battery may be expressed by Equation 3 below,

$${Q}_{BAT} = \frac{{I}_{P}^{2} L}{2 ( {V}_{BAT} - {V}_{IN} )} \qquad [ Equation 3 ]$$

Accordingly, as shown in FIGS. 11 and 12, values of the input voltage V_{IN} and the first time t₁ are grouped and calculated in advance so that the charge Q_{BAT} has a constant value, and the calculated values may be predefined or stored in a lookup table LUT or the like in the circuit.

The graph of FIG. 11 illustrates the relationship between the input voltage V_{IN} and the first time t₁ as a condition for the constant charge Q_{BAT} and the results used to maintain the condition. In FIG. 11, a first curve G1 represents the maximum current I_{P} and a second curve G2 represents the input voltage V_{IN}.

In the case of the above-described configuration, even when the value of the input voltage V_{IN} is changed to find out a target extraction voltage, the first time t₁ corresponding thereto is automatically set so that the value of the charge Q_{BAT} is constant, and thus, even when the input voltage V_{IN} is set to a certain value, the amount of charge delivered to the battery in a single operation may be fixed to a constant level, such as the charge Q_{BAT} described above.

Thus, according to the present exemplary embodiment, when counting how many times the switch of the energy harvester is operated within a preset time, this count may be used to determine the amount of power harvested during that time. Accordingly, a maximum power extraction voltage may be found by varying the target extraction voltage and comparing how many switch operations are performed in a preset period of time. In this manner, maximum power point tracking can be performed while omitting the conventional maximum power point tracking analog circuit consuming a large amount of power, thereby obtaining relatively high energy conversion efficiency even at the low input power P_{IN}.

Describing the above-described configuration in more detail using an example, in the FCS mode, the charge or charge amount delivered to the battery voltage V_{BAT} during a single energy harvesting operation may be fixed. When the charge or charge amount is fixed, the charge Q_{BAT} or charge amount may be obtained as pairs of the input voltage V_{IN} and the first time t₁ that varies according to the input voltage V_{IN}.

Meanwhile, in order to harvest a larger charge amount in the single energy harvesting operation, the number of switching operations should be reduced and the switching loss should be reduced. In addition, the instantaneous power loss I_{P}²R_{ON} due to the conduction loss should be kept lower than the input power I_{P}V_{IN}. That is, this becomes an essential condition expressed as I_{P}²R_{ON}<<I_{P}V_{IN}. Here, even at the input voltage V_{IN} of 0.2V under the operating condition in which the on-state switch resistance R_{ON} is 0.5, a desirable maximum current I_{P} of about 18 mA can be induced when the instantaneous power loss remains below 5% of the input power.

Thereafter, the first time t₁ for the charge Q_{BAT}, which is a constant, may be calculated. In this operation, the calculation for the given battery voltage V_{BAT} and inductance L shows that the first time t₁ is inversely proportional to the input voltage V_{IN} when the maximum current I_{P} changes by less than ±10% of 18 mA.

Next, at the beginning of operation, the V_{IN}-t₁ pairs, which have been obtained for the input voltage and the first time, are stored in the lookup table LUT and may be used in the FCS mode. At this time, the switch's single operation time t_{SW} is adaptively controlled by comparing the input voltage V_{IN} with the target input voltage V_{IN} or the maximum power point voltage VMPP. Switching for harvesting may be activated only when the input voltage V_{IN} exceeds the maximum power point voltage VMPP, so that a PFM mode is switched to a PSM mode. Here, the comparison cycle may be controlled such that the system frequency increases twice (×2) when the input voltage V_{IN} is greater than the maximum power point voltage VMPP. In addition, the comparison cycle may be controlled such that the system frequency of the PFM mode is decreased by ½ when the input voltage V_{IN} is not greater than the maximum power point voltage VMPP.

The actual operation principle of the FCS mode, i.e., an FCS-MPPT mode, of the present exemplary embodiment may be summarized as shown in FIG. 12.

First, when the input power is less than a preset reference value, the energy harvester may count a first number N₁, which is the number of switching (SW) events for the on/off operation of the second switch, at a previously given relatively long time period T_{meas,FCS} (S121). Through this process, the optimal first number N₁ of the switching events in the current FCS-MPPT mode may be determined.

Next, a first input voltage may be obtained from the lookup table LUT that stores the predefined pairs of the input voltage V_{IN} (hereinafter, also referred to as the “first input voltage”) and the first time t₁ for the preset fixed charge Q_{BAT}. That is, hill climbing may be performed while changing the first input voltage and setting the first time corresponding to the first input voltage, and a second number N₂, which is a different number of the SW events, may be counted in the above-described preset time period T_{meas,FCS} (S123). Through this process, the second number N₂ of the switching events at the maximum current I_{P} may be determined.

With this configuration, the voltage for maximum power point tracking can be found by comparing the number of switching events that occur over a predetermined time while changing the target extraction voltage. Through this, the number of switching events in the maximum power point tracking may be determined. As such, by merely counting the number of switching events, it is possible to calculate at what percentage (%) of the maximum power point tracking the energy is currently being harvested by the energy harvester or stored in the battery, and thus high-efficiency energy harvesting can be performed at relatively low input power without using the maximum power point tracking analog circuit.

Meanwhile, when the first number N₁ is greater than the second number N₂ during the operation of the FCS mode, operations S121 and S123 described above may be repeatedly performed until the second number N₂ is equal to or greater than the first number N₁, according to a set direction to backward (S125).

According to the present exemplary embodiment, counting the number of SW events during the preset period T_{meas,FCS} for each first time and first input voltage extracted from the first input voltage-first time pairs set according to the fixed charge Q_{BAT} allows the current measurement for the MPPT to be replaced with a simple calculation. Accordingly, the use of the MPPT analog circuit can be eliminated, and as a result, the quiescent current of the FCS-MPPT mode can be suppressed to be less than or equal to 2.2 nA. That is, energy can be harvested with high efficiency even with low input power of less than 1 mW.

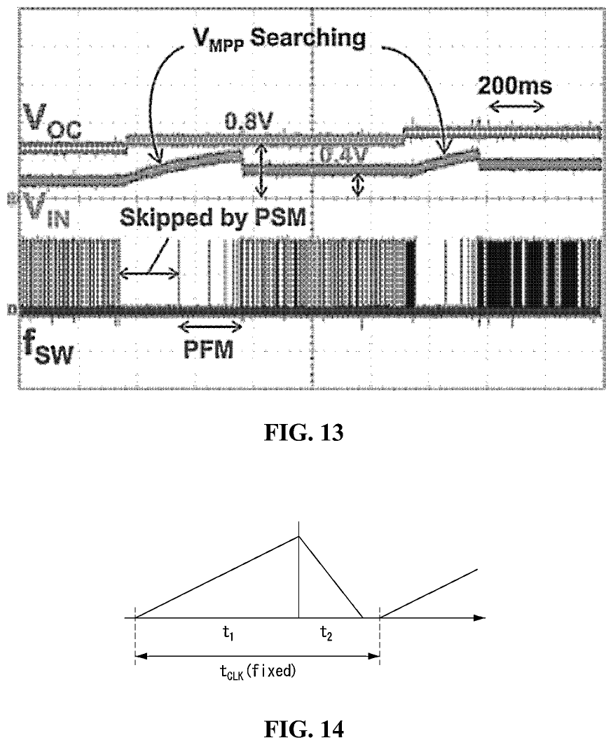

FIG. 13 is a graph for describing a transient response showing an FCS-MPPT operation in an environment in which an open-circuit voltage Voc is changed in the energy harvester of FIG. 1.

Referring to FIG. 13, in the FCS-MPPT mode of the energy harvester, the switching frequency f_{SW} may be adaptively changed using pulse-skip modulation (PSM) and pulse-frequency modulation (PFM) according to a change in the open-circuit voltage Voc.

That is, according to measurement results of the transient response showing the MPPT operation in each mode, in a state in which the predetermined switching frequency f_{SW} is input as a result of searching for the maximum power point voltage (VMPP searching) with an open input voltage of 0.8 V, the energy harvester may operate in the FCS mode with PSM when the input voltage V_{IN} is less than 0.4 V and may operate in the FFS mode with PFM when the input voltage V_{IN} is greater than or equal to 0.4 V.

At this point, in the FCS mode, the system frequency f_{CLK} output from the leakage-based digitally controlled oscillator (of the DCO) can be adaptively changed by repeatedly increasing by 2 or ½ times in a preset range according to the comparator output, thereby allowing the switching frequency to be intermittently skipped. That is, in the FCS mode, the generation of the switching frequency can be omitted by the PSM, and thus, some of the switching events for the on/off operation of the switch can be omitted, thereby reducing power consumption.

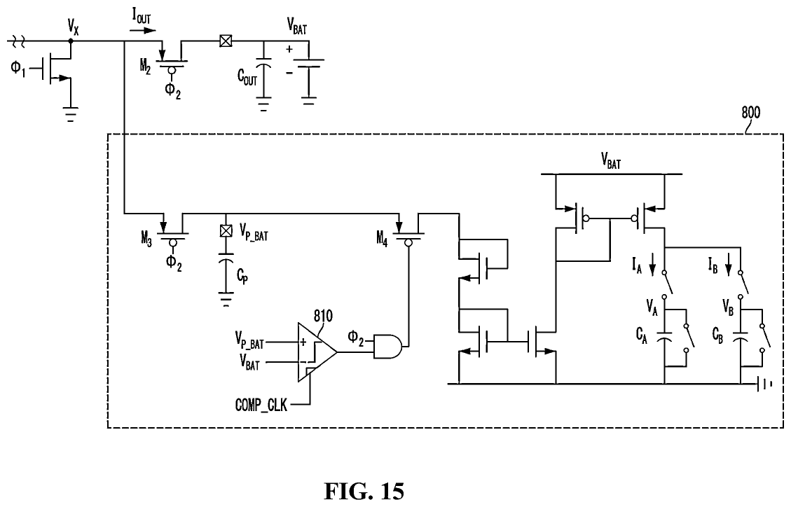

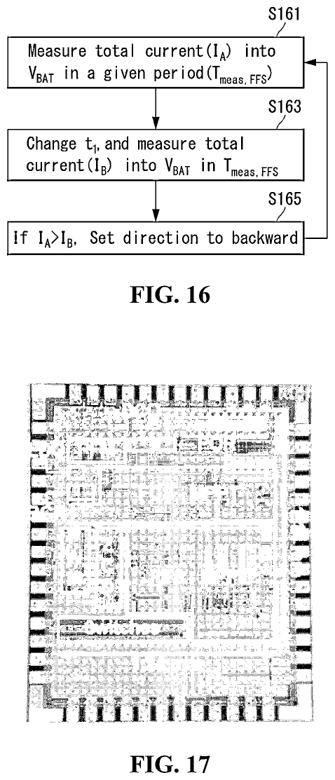

FIG. 14 is a graph for describing FFS-MPPT that may be employed in the energy harvester of FIG. 1. FIG. 15 is an exemplary diagram of a control circuit configured to compare harvested charges in the FFS mode that may be employed in the energy harvester of FIG. 1. In addition, FIG. 16 is a flowchart illustrating an operation process of the FFS mode of FIG. 14.

In the present exemplary embodiment, an FFS-MPPT circuit will be described in which a fixed frequency search that tracks the maximum power point over an input power range of 1 mW or more, in which the above-described FCS-MPPT circuit may not operate, is used. The FFS-MPPT circuit is an MPPT circuit that minimizes power loss and widens an input power range.

In other words, since the FCS-MPPT circuit described above fixes the amount of charge delivered to the battery in a single operation, in an environment in which the input power P_{IN} is 1 mW or more, even when a switch operation speed is increased, the speed of delivering the harvested energy to the battery becomes relatively slow, and eventually, the algorithm of the FCS-MPPT circuit that depends on the speed of the switch may not work properly. Thus, the energy harvester of the present exemplary embodiment may be set to automatically switch to the FFS-MPPT circuit by causing a trigger to occur when the switching speed is maximized within a set value.

Referring to FIG. 14, the FFS-MPPT circuit controls the amount of harvested energy by fixing the switch operating speed of a single cycle to the maximum, i.e., the system frequency t_{CLK} to the maximum, and adjusting the value of the first time t₁, which determines the amount of charge delivered to the battery. Since the condition under which the FFS-MPPT circuit operates is when the input power P_{IN} is relatively large or the maximum, the power used may be less than the harvested power when using the conventional analog circuit that evaluates the maximum power point.

In the FFS-MPPT circuit of the present exemplary embodiment, as illustrated in FIG. 15, a portion of a current I_{OUT} delivered to the battery in a first state is copied and accumulated in a first capacitor C_{A}, and the value of the first time t₁ is changed, and then, in the changed state (hereinafter, referred to as a “second state”), a portion of the current delivered to the battery for the same time as before is also copied and accumulated in a second capacitor C_{B}, which is different from the first capacitor. As described above, the maximum power point may be tracked by comparing the currents accumulated in the first state and the second state, that is, how much current is directly copied for the same time may be tracked by comparing the voltages V_{A} and V_{B} respectively generated in the first capacitor C_{A} and the second capacitor C_{B}.

In other words, the switch-on operation time t_{SW} in the FCS mode will eventually reach a minimum value (=1/fₘₐₓ) as the input power increases. Then, the MPPT mode is then automatically switched to the FFS mode. In the FFS mode, the total current I_{OUT} (hereafter referred to as “output current”) flowing into the battery in the given period T_{meas,FFS} may be estimated using a copied branch. The given period T_{meas,FFS} may be generated by adaptively dividing the maximum frequency fₘₐₓ while a system clock, i.e., the system frequency, is fixed to a predetermined maximum frequency fₘₐₓ.

Referring to FIG. 15, an MPPT control circuit is illustrated in which hill climbing is perform by comparing harvested charges through the copied branch of the output current I_{OUT}. That is, the energy harvesting apparatus of the present exemplary embodiment may include the MPPT control circuit, and here, the MPPT control circuit may include a copied branch circuit 800. The copied branch circuit 800 may be referred to as a scaled replica branch circuit capable of adjusting the intensity of a branch current.

The copied branch circuit may include a third switch M₃, a fourth switch M₄, a diode switch, a first current mirror, a second current mirror, and a plurality of switched capacitors. In this case, a first terminal of the third switch M₃ may be connected in parallel to a first terminal of the second switch M₂ at an input side to branch the output current. A first terminal of the fourth switch M₄ is connected to a second terminal of the third switch M₃, and a trigger signal for the replication operation of the output current I_{OUT} may be input to a control terminal of the fourth switch M₄. The level of the trigger signal may be determined by an output value of the AND gate, which is obtained using the second control signal Φ₂ and a comparison result of the battery voltage V_{BAT} and a ground voltage V_{P_BAT} according to a comparator clock COMP_CLK. A second terminal of the fourth switch M₄ may be connected to one end of the first current mirror at an input side through the diode switch. The other end of the first current mirror at the input side may be connected to one end of the second current mirror at an output side. The other end of the second current mirror at the output side may be connected in parallel to a first terminal of the first capacitor C_{A} having a first parallel switch and a first terminal of the second capacitor C_{B} having a second parallel switch. A first capacitor switch may be connected between the other end of the second current mirror at the output side and the first terminal of the first capacitor C_{A}, and a second capacitor switch may be connected between the other end of the second current mirror at the output side and the first terminal of the second capacitor C_{B}. Two input side terminals of the second current mirror may be connected to nodes having the battery voltage V_{BAT}. In addition, two output side terminals of the first current mirror and a second terminal of each of the second capacitors C_{A} and C_{B} may be connected to the ground.

According to the copied branch circuit described above, a first capacitor voltage V_{A} and a second capacitor voltage V_{B} may be generated through currents, which are scaled from the output current I_{OUT} and flowing into the first capacitor C_{A} and the second capacitor C_{B} during the same period, that is, a first capacitor current I_{A} and a second capacitor current I_{B}, and thereafter, the two voltages may be compared with each other.

When the first capacitor voltage V_{A} and the second capacitor voltage V_{B} are compared, a tendency of increasing or decreasing the output current may be identified, and maximum power point tracking may be performed by comparing these two capacitor voltages.

As shown in FIG. 16, the above-described FFS mode may be configured to treat the first time t₁ as a control variable for hill climbing, i.e., PWM, rather than being determined by the lookup table LUT as in the FCS mode.

To this end, the energy harvester may measure a total current flowing into the battery for a preset time, cycle, or period T_{meas,FFS} (hereinafter “replication time”) (S161). Here, the total current may correspond to a first output current I_{A}. Next, the first time t₁ may be changed, and a total current flowing into the battery during the replication time may be measured (S163). Here, the total current may correspond to a second output current I_{B}.

When the first capacitor voltage V_{A}, which is the result at the previous first time t₁, is greater than the second capacitor voltage V_{B}, which is the result at the current first time t₁, or similarly, the first output current I_{A} is greater than the second output current I_{B}, the direction of the state change for maximum power point tracking may be set to backward (S165). Here, the first capacitor C_{A} and the second capacitor C_{B} may have the same component specification.

Meanwhile, when the first capacitor voltage V_{A} is not greater than the second capacitor voltage V_{B}, the comparison of the two voltages for the required time may be repeatedly performed while maintaining the direction of the state change for maximum power point tracking.

With this configuration, the input voltage V_{IN} may be automatically settled to the maximum power point voltage VMPP at the optimal first time t₁, thereby effectively harvesting energy through maximum power point tracking in the FFS mode.

FIG. 17 is a die photograph of a structure that may be employed in the energy harvester of FIG. 1.

Referring to FIG. 17, the energy harvester may be manufactured as a single chip or in the form of an IC mounted on a single board. The manufactured energy harvester IC may include an FCS-MPPT part, an FFS-MPPT part, a switch part, a PWM part, a ZCD part, a BGR part, an LDO part, a PFM part, a DCO part, and a POR part. The manufactured energy harvester IC may have a chip size of 1.14 mm×1.24 mm.

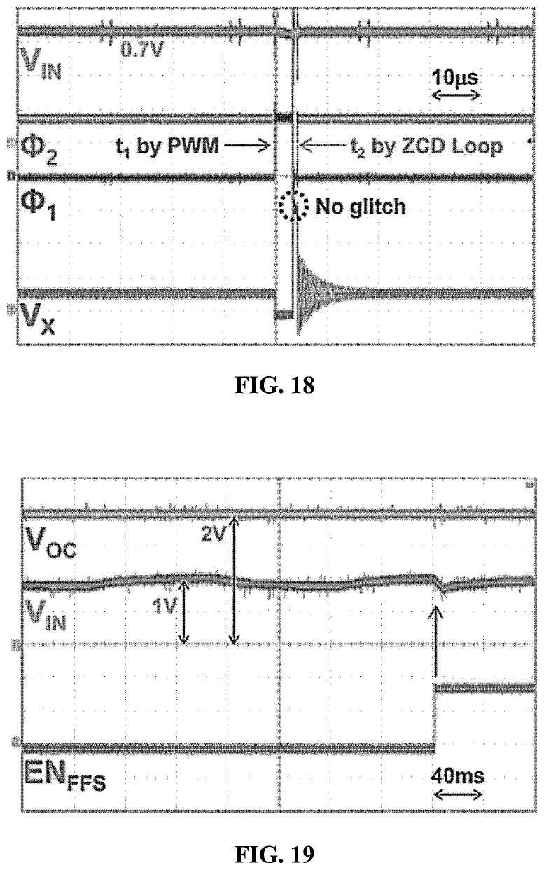

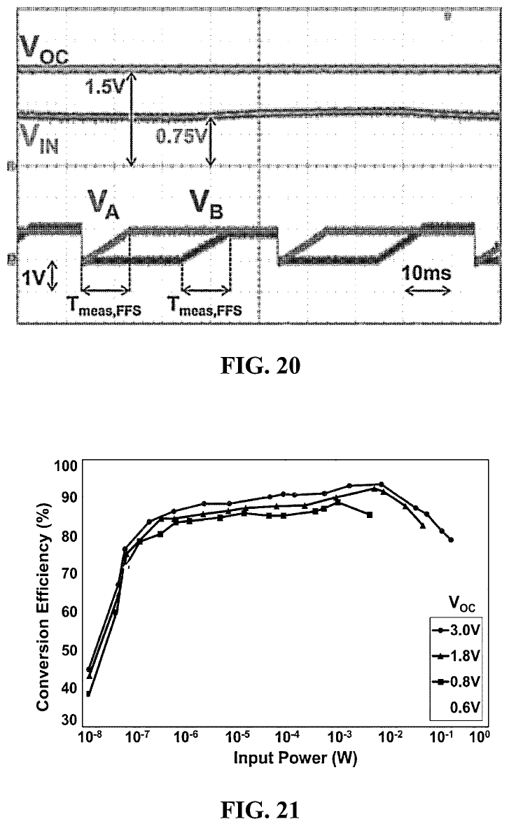

FIG. 18 is a graph for describing a transient response showing a ZCD in the energy harvester of FIG. 1. FIG. 19 is a graph for describing a transient response showing a mode change from the FCS mode to the FFS mode in the energy harvester of FIG. 1. In addition, FIG. 20 is a graph for describing a transient response showing a steady state of the FFS-MPPT in the energy harvester of FIG. 1.

Referring to FIG. 18, it may be seen that there is no abnormal glitch between the first and second control signals Φ₁ and Φ₂ at the first time t₁, which is generated by the PWM operation of the energy harvester in an input power environment of the input voltage V_{IN} of 0.7V and the predetermined internal input voltage Vx, and the first and second control signals Φ₁ and Φ₂ at the second time t₂ generated by the ZCD loop.

As described above, by configuring the energy harvester of the present exemplary embodiment to generate the first time t₁ corresponding to the on-time of the first switch by the PWM part, and to generate the second time t₂ corresponding to the on-time of the second switch by the ZCD loop itself connected to the PWM part, a reverse current flowing from the battery into the energy harvester can be suppressed.

Referring to FIG. 19, when the input power increases, a transient phenomenon from the FCS mode to the FFS mode may be checked. This mode change may be triggered by a flag, which is the mode selection signal EN_{FFS} generated in the mode selector of the MPPT part. After the mode change, the input voltage V_{IN} may be quickly reset to an optimal level using an FFS algorithm.

The steady state of the FFS mode is illustrated in FIG. 20. An on-chip single gain buffer may be further used to observe the first capacitor voltage V_{A} and the second capacitor voltage V_{B}. At this time, the preset period T_{meas,FFS} may be set to be automatically determined when the first capacitor voltage V_{A} is about 1 V. It may be confirmed that the input voltage V_{IN} settles to about 0.75 V when hill climbing for approaching the target value is performed by comparing the first capacitor voltage V_{A} and the second capacitor voltage V_{B}. As a result of the measurement, it may be seen that the input voltage V_{IN} is automatically stabilized to 0.5 times the open-input voltage Voc without fractional open-circuit voltage (FOCV) sampling.

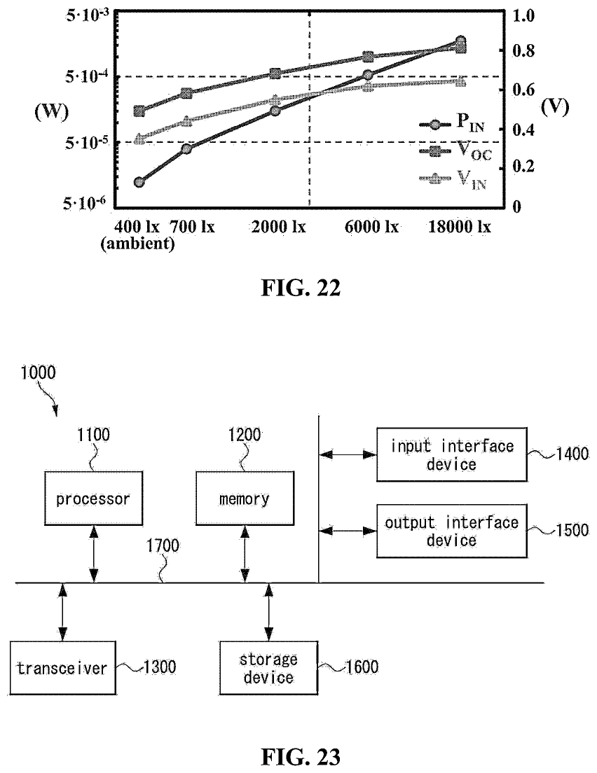

FIG. 21 is a graph showing conversion efficiency of the energy harvester of FIG. 1 measured for various input powers under various open-circuit voltage conditions at a constant battery voltage. In addition, FIG. 22 is a graph showing a result of verifying the energy harvester of FIG. 1 with a commercial solar cell exposed to various light intensities.

Referring to FIG. 21, conversion efficiency measured for various input powers under open-input voltage Voc conditions at the battery voltage V_{BAT} of 3.3 V may be seen. That is, the energy harvester may operate in the FCS mode when the input power is within a few mW. Although the efficiency drops to a sub-μW range due to non-negligible standby power consumption, the IC can still harvest energy at an input power of tens of nW.

When the input power increases, the energy harvester is automatically switched from the FCS mode to the FFS mode. At this time, the efficiency may remain above 80% up to 180 mW.

In addition, as shown in FIG. 22, the energy harvester may be verified with a commercial solar cell exposed to various light intensities. The MPPT of the energy harvester may adjust the input voltage V_{IN} to about 0.8 times the open-input voltage Voc, i.e., the maximum power point voltage VMPP specified in the data sheet, at test intensities ranging from ambient room light to 18,000 lx.

Meanwhile, the energy harvesting apparatus according to the present exemplary embodiment may be mounted on an IoT device that receives power from an energy source utilizing photovoltaic, thermal, kinetic, magnetic, or piezoelectric energy. For example, the IoT device may include a wearable photocell that generates power of milliwatts under a typical operating condition. In addition, the IoT device may include a wearable sensor, a health monitoring sensor, a biometric sensor, a wireless sensor, a smart watch, smart glasses, and the like.

FIG. 23 is a schematic block diagram of an energy harvesting apparatus according to another exemplary embodiment of the present disclosure.

Referring to FIG. 23, an energy harvesting apparatus 1000 may include at least one processor 1100 and at least one program command mounted on the at least one processor 1100. In addition, the energy harvesting apparatus 1000 may further include at least one of a memory 1200 and a transmitting and receiving device 1300 connected to a network to perform communication therewith. In addition, the energy harvesting apparatus 1000 may further include an input interface device 1400, an output interface device 1500, a storage device 1600, and the like. Each of the components provided in the energy harvesting apparatus 1000 may communicate with each other by being connected by a bus 1700.

However, each of the components included in the energy harvesting apparatus 1000 may be connected to the processor 1100 through an individual interface or an individual bus rather than the common bus 1700. For example, the processor 1100 may be connected to at least one of the memory 1200, the transmitting and receiving device 1300, the input interface device 1400, the output interface device 1500, and the storage device 1600 via a dedicated interface.

The processor 1100 may execute the program command stored in at least one of the memory 1200 and the storage device 1600. The program command may include a command for changing a first time and measuring a current flowing to a battery through a second switch during each changed first time, and a command for comparing currents, which are measured according to the change of the first time, flowing into the battery. According to the comparison command, the currents flowing to the battery for the first times different from each other are copied and stored by a current mirror included in a comparison part, and a first capacitor and a second capacitor connected in parallel to an output terminal of the current mirror at one side. In addition, the program command may further include a command for tracking a maximum power point on the basis of the comparison result according to the comparison command, a command for storing first input voltage-first time pairs corresponding to a preset fixed charge amount for the battery, a command for counting a first number, which is the number of switching events for the on/off operation of the second switch for a preset time, when the comparator output is less than a reference value, and a command for counting a second number of switching events of the second switch for each first time corresponding to the first input voltage, which is extracted while changing the first input voltage extracted from the storage device, when the comparator output is less than the reference value. Here, the tracking command may include a command for setting the first input voltage at the first time, which has the highest number of switching events among the second numbers obtained from a second counter, to a maximum power extraction voltage according to an operation mode.

The processor 1100 may refer to a central processing unit (CPU), a graphics processing unit (GPU), or a dedicated processor on which the methods according to the exemplary embodiments of the present disclosure are performed.

Each of the memory 1200 and the storage device 1600 may include at least one of a volatile storage medium and a non-volatile storage medium. For example, the memory 1200 may include at least one of a read-only memory (ROM) and a random access memory (RAM).

The transmitting and receiving device 1300 may include a communication interface or a sub-communication system for connection to a local area network or cable, communicating with a satellite, communicating with a mobile communication base station, and the like.

The input interface device 1400 may include at least one input device selected from a keyboard, microphone, touchpad, touchscreen, and the like, and an input signal processing part for mapping or processing a signal input through the at least one input device with the previously stored command.

The output interface device 1500 may include an output signal processing part for mapping or processing a signal output according to the control of the processor 1100 to a pre-stored signal form or level, and at least one output device for outputting a signal or information in the form of vibration, light, or the like in response to a signal of the output signal processing part. The at least one output device may include at least one selected from output devices such as a speaker, a display device, a printer, a light output device, a vibration output device, and the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An energy harvesting method of an energy harvesting apparatus configured to convert input power coming from an energy source using a switching frequency, which is generated by monitoring an input voltage, and a first time and a second time, which are on-times of a first switch and a second switch, respectively, and generated based on the switching frequency, and deliver the converted input power to a battery, the energy harvesting method comprising:
counting a first number, which is the number of switching events for an on/off operation of the second switch during the first time, when the input power is less than a preset reference value;
counting a second number of switching events of the second switch for each first time while changing a first input voltage from first input voltage-first time pairs pre-stored in relation to a preset fixed charge amount for the battery; and
setting the first input voltage of the first time having the highest number of switching events among the second numbers obtained in the counting as a maximum power extraction voltage.

2. The energy harvesting method of claim 1, wherein the first time is proportional to a fractional value with the first input voltage as a denominator.

3. The energy harvesting method of claim 1, wherein the reference value is a power of several milliwatts (mW).

4. The energy harvesting method of claim 1, further comprising setting an input voltage that causes the first time to be maximized as the maximum power extraction voltage, when the input power is greater than or equal to the reference value.

5. The energy harvesting method of claim 4, further comprising:
measuring a first current flowing to the battery through the second switch during the second time;
measuring a second current flowing to the battery through the second switch during a third time obtained by changing the second time; and
tracking the maximum power extraction voltage by comparing the first current and the second current.

6. An energy harvesting method of an energy harvesting apparatus configured to convert input power of an energy source using a switching frequency, which is generated by monitoring an input voltage, and a first time and a second time, which are on-times of a first switch and a second switch, respectively, and generated based on the switching frequency, and store the converted input power in a battery, the energy harvesting method comprising:
maximizing a system frequency of the energy harvesting apparatus when the input power is greater than or equal to a preset reference value;
adjusting the first time that determines an amount of charge delivered to the battery;
measuring a current flowing to the battery through the second switch according to the adjustment of the first time; and
tracking a maximum power point on the basis of a comparison result of the currents flowing to the battery.

7. The energy harvesting method of claim 6, further comprising shortening a period of the system frequency to increase a system clock per unit time, when the input power is greater than or equal to the reference value.

8. The energy harvesting method of claim 6, wherein the measuring of the current includes measuring a first current flowing to the battery at the first time using a current mirror, and measuring a second current flowing to the battery at another first time obtained by changing the first time using the current mirror, and
the tracking of the maximum power point includes comparing a first capacitor voltage and a second capacitor voltage, which are charged to a first capacitor and a second capacitor connected to the current mirror, respectively.

9. The energy harvesting method of claim 6, further comprising changing an operation mode when the input power is less than the reference value.

10. The energy harvesting method of claim 9, further comprising:
counting, in the changed operation mode, a second number of switching events of the second switch while changing a first input voltage from first input voltage-first time pairs pre-stored in relation to a preset fixed charge amount for the battery; and
setting, in the changed operation mode, the first input voltage at the first time having the highest number of switching events among the second numbers, which are obtained in the counting of the second number, as a maximum power extraction voltage.

11. An energy harvesting apparatus configured to convert input power coming from an energy source and deliver the converted input power to a battery, the energy harvesting apparatus comprising:
a first switch connected between a point between an input terminal and an output terminal, and the ground;
a second switch serially connected to the point between the input terminal and the output terminal, and disposed adjacent to the output terminal;
a switch pulse generator configured to generate a system frequency and a trigger signal by monitoring an input voltage, generate a switching frequency on the basis of the system frequency, generate a first time and a second time, which are on-times of the first switch and the second switch, respectively, on the basis of the switching frequency, and generate a first control signal for the first switch and a second control signal for the second switch on the basis of the first time and the second time; and
a maximum power point tracking (MPPT) part configured to generate a mode selection signal for selecting an operation mode on the basis of the trigger signal, and generate a digital code using one of a first MPPT engine and a second MPPT engine activated according to the mode selection signal,
wherein the switch pulse generator operates in a first operation mode when the input voltage is less than a preset reference value, and shortens a period of the system frequency and operates in a second operation mode when the input voltage is greater than or equal to the reference value.

12. The energy harvesting apparatus of claim 11, wherein the switch pulse generator includes:
a voltage divider configured to generate a reference voltage obtained by dividing a battery voltage on the basis of a first digital signal generated by the first MPPT engine; and
a comparator configured to compare the input voltage with the reference voltage corresponding to the reference value, and generate a comparator output for indicating an active or enabled state when the input voltage is greater than or equal to the reference voltage.

13. The energy harvesting apparatus of claim 12, wherein the switch pulse generator further includes:
a digitally controlled oscillator configured to generate the system frequency according to the comparator output and output a flag which is the trigger signal at a maximum system frequency;
an OR gate having the comparator output and a second digital signal generated in the second MPPT engine as two inputs; and
an AND gate having an output of the OR gate and the system frequency as two inputs.

14. The energy harvesting apparatus of claim 13, further comprising:
a pulse-width modulation (PWM) part having the switching frequency, which is an output of the AND gate, the first digital signal, and the second digital signal as three inputs and configured to output the first time;
a zero current detection (ZCD) part having the first time transmitted from the PWM part, the battery voltage, and an internal input voltage applied to a first terminal of the second switch at a source side as three inputs, and configured to output the second time; and
a switch driver having the first time, the second time, and the battery voltage as three inputs and configured to output the first control signal and the second control signal.

15. The energy harvesting apparatus of claim 14, wherein when the comparator output is greater than or equal to the reference value,
the digitally controlled oscillator maximizes the system frequency of the energy harvesting apparatus, and
the PWM part changes the first time that determines an amount of charge delivered to the battery.

16. The energy harvesting apparatus of claim 15, wherein when the comparator output is greater than or equal to the reference value, the digitally controlled oscillator increases the system frequency by two times, and
when the comparator output is changed below the reference value, the digitally controlled oscillator returns the system frequency or reduces the system frequency by ½.

17. The energy harvesting apparatus of claim 15, further comprising:
a measurement part configured to measure a current flowing to the battery through the second switch during each changed first time;
a comparison part configured to compare the currents flowing to the battery, which are measured according to the changing of the first time; and
a tracking part configured to track a maximum power point on the basis of a comparison result of the comparison part.

18. The energy harvesting apparatus of claim 17, wherein the comparison part includes a current mirror, and a first capacitor and a second capacitor connected in parallel to an output terminal of the current mirror at one side, wherein each of the first capacitor and the second capacitor copies and stores the currents flowing to the battery for different first times.

19. The energy harvesting apparatus of claim 12, further comprising:
a storage part configured to store first input voltage-first time pairs, which correspond to a fixed amount of charge, preset for the battery;
a first counter configured to count a first number, which is the number of switching events for an on/off operation of the second switch during a preset time, when the comparator output is less than the reference value;
a second counter configured to count a second number of switching events of the second switch for each first time corresponding to a first input voltage extracted from the storage part while changing the first input voltage, when the comparator output is less than the reference value; and
a tracking part configured to set a first input voltage at the first time having the highest number of switching events among the second numbers obtained by the second counter as a maximum power extraction voltage.

20. The energy harvesting apparatus of claim 12, wherein a reference value of an input current according to the reference voltage is a power of several milliwatts (mW).
